(19) United States
(12) Patent Application Publication
(10) Pub. No.: US 2017/0243294 A1
(43) Pub. Date: Aug. 24, 2017

(54) Rubix System

(71) Applicant: Charles J. Shure, New York, NY (US)

(72) Inventor: Charles J. Shure, New York, NY (US)

(21) Appl. No.: 15/046,861

(22) Filed: Feb. 18, 2016

(51) Int. Cl. G06Q 40/06; G06Q 50/00

(52) U.S. Cl. CPC G06Q 40/06; G06Q 50/01

(57) ABSTRACT

This invention relates to a method for facilitating a communication between an inventor or product developer and an investor through an online platform such as social networking platform websites, online invention marketplace. Further, the method allows the inventor to submit an idea to the online platform. Further, the method allows the inventor to communicate with other inventors and create a team to develop the idea or invention into a product. Further, the method is adapted facilitates investment in an inventor's invention by providing the invention to potential investors at preliminary stages of invention development.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

The present disclosure generally relates to a system to protect and commercialize inventive ideas, and more particularly, to providing an automated platform to enable invention development, product development and investment transactions.

(2) Background of the Invention

Many people from all walks of life have ideas for patentable products or methods. Although many inventors work in specialized technological fields and are employed in companies, universities or organizations which are familiar in protecting their employees' inventions, some inventors are not experts in any technological field, and have ideas for patentable products or methods in fields not related to their work. However, as most companies do not accept unsolicited ideas under confidentiality, the inventors can hire a lawyer and file a patent application first before approaching these companies.

In recent years, the importance of devising good ideas has been increasingly emphasized as the knowledge-based information society takes its way However, even if an individual strikes on a fine idea, it is often the case that the idea is buried without carrying any fruits due to the lack of time, money, and/or other know-how which is necessary for commercialization of the idea. Further, on the part of the investors, they are willing to invest in a promising idea, they have seldom opportunities to come to contact with ideas waiting for investment, or they cannot make proper investments due to their incapability to appraise the marketability of the idea even in case they fortunately encounter such an idea. Furthermore, assuming that an investor has made an adequate investment in an idea, there still exists such a shortage that he cannot record his invested capital in a short period of time, since it takes long time until the investment begins to accrue to the investor after the successful commercialization of the idea.

Unfortunately, successfully engaging in product design, manufacturing, and distribution for retail sale for a product embodying a great idea can be more complex, more time consuming, and more expensive than the patenting process itself, and such ordinary people are faced with an almost insurmountable challenge in doing so.

Some examples of the systems are illustrated below with reference to pertinent documents.

U.S. patent application Ser. No. 14/205,079 from Doron Etzioni, et al. teaches an online platform that provides academic users with collaboration tools to exchange and build on the accumulated knowledge of subjects of interest. Users are provided with a central location to collect, categorize, and rank resources, and store notes and comments related to a particular section of an electronic textbook being studied. Users also can refer to online resources, such as web services, multimedia, website pages, newsgroups, search engine results, RSS, any other current and future external resources, and other user's notes.

U.S. patent application Ser. No. 12/059,685 from Andrew T. Ramer, teaches a method for transacting intellectual property includes the steps of receiving an executed document transferring an intellectual property right to an undefined party; receiving one or more offers for the intellectual property right; determining a winning party based on the one or more received offers; and releasing the executed document to the winning party. The method may further include placing the executed document in a data room for review by a potential acquirer prior to receiving one or more offers for the intellectual property night.

U.S. Pat. No. 7,536,310 B2 from Norbert Klausnitzer, teaches a method of managing an idea management system and providing the system as a service to a third party (e.g. a customer). By this configuration, ideas originated by employees of the customer can flow into the products or services of the provider of the idea management system.

U.S. patent application Ser. No. 11/423,448 from Stancombe Todd, teaches a method of finding and commercializing extraordinary ideas of ordinary people includes: receiving, by a first party, from each of a plurality of persons, a disclosure of an idea of the person and, for each person from whom a disclosure of an idea is received, identifying a good or service (collectively “Product”) embodying the disclosed idea, considering patentability of the Product, and considering commercial feasibility of the Product.

Accordingly, a need has been felt for a method and system for assisting inventors in developing, protecting and marketing their inventions.

### SUMMARY OF THE INVENTION

An object of the invention is to provide a method for facilitating a communication between an inventor or product developer and an investor through an online platform such as social networking platform websites, online invention marketplace. Further, the method is adapted to allow the inventor to submit an idea to the online platform. Further, the method allows the inventor to develop the idea into a digital model through the 3-D geometric software provide by the online platform. Further, the method allows the inventor to communicate with other inventors and create a team to develop the idea or invention into a product.

It is another object of the present invention to provide an online platform to aid inventors, at no cost or at minimal cost, to develop their ideas. The online platform is adapted to assist the inventors in searching, filing patent applications, developing their inventions and licensing the patent applications.

It is another object of the present invention to provide an online platform which is adapted facilitates investment in an inventor's invention by providing the invention to potential investors at preliminary stages of invention development, allowing investors to fund activities such as searching, product development, and commercialization of product, marketing and patent application drafting and filing. Investors may continue to invest after patent application drafting.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates a flowchart of a method for submitting an invention to the online platform, according to the various embodiments of the present invention.

FIG. 2 illustrates a flowchart of a method for investing in an invention of interest through the online platform, according to the various embodiments of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

As used in this application, the term “computing device” refers to a computer-related entity, hardware, firmware, software, a combination thereof, or software in execution. For example, a software loaded on a computing device can be, but is not limited to being, a process running on a processor unit, a processor, an object, an executable, a thread of execution, a program, and a computer. By way of illustration, both an application running on a server and the server can be computing device. One or more computing units can reside within a process and/or thread of execution and a computing unit can be localized on one computer and/or distributed between two or more computers.

The term “inventor” refers to a person who invent or a person have an idea, students, teacher, professor, university, company, organization, creator, innovator, designer, developer, manufacturer, planner, scientist, discoverer, investor and the like.

The term “investor” as used herein, is defined as a person who allocates capital with the expectation of a future financial return. The term “investor” may be used to represent an inventor, company, organization, manufacture, bank, financial institution and the like.

The term “online platform” as used herein, is defined as a website which is connected to a server.

The online platform is established on the Internet. This is done in the usual way and involves creating an Internet address, registering a domain name, hosting domain on an internal server or external third-party server, creating a home page and a link to a plurality of web pages defining a website designed as an online platform for assisting the inventor and investor. A link to the online platform for the home page is established in the usual manner, e.g. utilizing a point and click icon, hyperlink or providing a selection menu for entering line commands.

The present invention generally provides a system and method that provide an improved, tangible, online platform such as an online invention marketplace. An embodiment may be implemented by a system, computer readable medium or a method or any combination thereof. The systems and methods include a unique combination of one or more features associated with the online invention marketplace. In one embodiment, the system provides a marketplace for interested investors and inventors to engage in transactions to develop a product from an invention. The system may be implemented as a web-based system that provides a process for managing the marketing and sales process of licensing and commercializing the developed product. In one embodiment, the system facilitates deal negotiation and execution, while also providing search and referral services for investment.

In one embodiment of the present invention, the present invention provides a system that includes a server for establishing a relationship between one or more inventor computing devices and investor computing devices via wireless communication. Further, the system includes determining, using predetermined criteria, for providing best invention to the investor. Further, the system allows one or more inventor to communicate with each other for developing a common product from an invention or idea. Further, the system includes a single database which is connected to the server. Further, the database is adapted to store inventor and investor information. Further, the system is adapted to allow the inventor to submit an idea through a computing device to the online platform via wired or wireless communication. Further, the system is adapted to allow the investor to invest in the invention/idea of interest.

In one embodiment of the present invention, the present invention provides a method performed by a processor enabled device for developing and receiving funds for an invention. Further, the method is adapted to receive, by a server, at least one invention idea from at least one inventor through an inventor's computing device via network communication. Further, the invention idea includes at least one invention parameter and at least one inventor activity. Further, the invention idea is at least one of a text, digital content, program, user interface, coding, website or software program codes, invention description or claim, abstract idea, product model, 3D digital model, image, business idea, image, information of any idea and combination thereof. Further the invention parameter is at least one of an inventor profile, inventor's profession, education and skills, technology used in the at least one invention idea, utility, scope of the invention, an advantage over prior invention, industrial application, novel aspects, market scope and the combinations thereof. Further, the inventor activity is at least one of a patent filing, drafting, product development, commercialization, promotion, branding, advertising, hiring of resources, manufacturing and the combination thereof.

Further, the method is adapted to provide ranking level to the invention idea based on the invention parameter. Further, the ranking level shows the worth of the invention idea. Further, the ranking level can be provided by the market or invention experts. Further, the ranking level can be automatically generated by analyzing the invention parameter. Further, the method allows the server to store the invention idea with the ranking level in an invention database which is coupled to the server. Further, the method allows the server to receive the invention search request from the investor via an investor computing device via the network communication. Further, the invention search request is at least one of a text, number, alphanumeric, symbol, image and the combination thereof. Further, the network communication is selected from the group of a wired communication, wireless communication and combination thereof. Further, the method allows the server to retrieve the invention idea, based on the invention search request, from the database. Further, the method allows the server to create creating a dynamic list of the retrieved invention idea based on the ranking level.

Further, the method allows the server to provide the dynamic list to the investor computing device via the network communication. Further, the method allows the investor to select at least one invention idea from the list provided, for investing funds in the at least one invention idea. Further, the investing funds are used in the at least one inventor activity.

In one embodiment of the present invention, the method allows the server to create a predefined contract between the inventor and the investor. Further, if the predefined contract is accepted by the inventor and the investor, the server establishes a fund transaction link between the inventor's computing device and the investor computing device via a payment gateway provided by the server via network communication. Further, the payment gateway is adapted to receive payment information such as bank account information of investors and the payment information of the inventor. After authenticating the payment information, the method allows the server to receive funds from the investor, according to the predefined contract and transmits the received funds to the at least one inventor. After the payment process, the method allows the server to send a transaction completion notification to the inventor's computing device and the investor computing device. Further, the predefined contract is at least one of a joint development agreements, licensing and cross-licensing agreements, and assignments of patent rights, copyright, profit sharing, revenue sharing, general contracts, contract services and the combination thereof.

In one embodiment of the present invention, the method is adapted to implement a standardized set of agreements prior to disclosure of the invention idea between the investor and the inventor. Further, the method allows the inventor to access at least one invention developing interface provided by the server, for developing a prototype 3D model based on the one invention idea. The invention developer interface is a 3D geometric software for developing a 3D prototype product model.

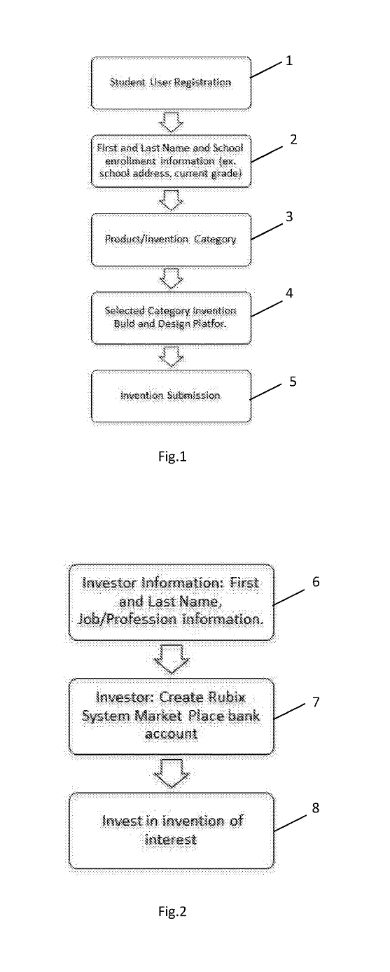

Now referring to FIG. 1, there is shown a flow chart of a method for submitting an invention to the online platform. The method allows a student/inventor to start a registration process by accessing the online platform via a computing device at step 1. Further, the registration process includes a step of creating User ID and password. Further, the method allows the student/inventor to send personal information to the online platform through the computing device via internet at step 2. Further, the personal information of the student/inventor includes a first name, last name, school/university/company enrollment information, address, interest, hobbies, technology skills and the like. After registration process, the method allows the student/inventor to select product/invention category and provide an invention disclosure through the computing device by the inventor at step 3, wherein the invention disclosure includes a synopsis of the invention. Further, the method allows the student/inventor to choose and access an invention building software for developing the product/invention digital model at step 4, wherein the invention building software is 3-D geometric software like CAD, MATLAB, etc.

In one embodiment of the present invention, the invention building software is related to Mechanical, Electrical, Software, Environmental, Civil, Chemical, and Computer Engineering software, and is also applicable to all forms of products or services including but not limited to Automotive, Aerospace, Medical, Consumer, Commercial, Defense, Electronics, Household Goods, Sporting Good and the like. Further, the invention building software is adapted to assist the inventor to develop a product based on his/her invention. Further, the invention building software allows an inventor to save and resume the invention development process.

Further, at step 5, the method allows the student/inventor to submit the invention disclosure to the online platform via wired or wireless communication.

In one embodiment of the present invention, the method allows the inventor to create a friend list by sending a friend request to other registered inventors through the online platform. Further, the method allows the inventor to communicate to other inventors via chatting application provided by the online platform. Further, the method allows the inventor to send an invitation to other inventors to participate in the invention development process. Further, the method allows the inventor to divide the invention into sub-module and allocate the sub-module to the other inventor through the invention building software for developing the product/invention via online platform. Further, the method allows the inventor to track the process status of the allocated sub-module through the invention building software for developing the product/invention via online platform.

In one embodiment of the present invention, the method allows the inventor to develop the idea into a digital product model through the 3-D geometric software provide by the online platform. Further, the method allows the inventor to communicate with other inventors and create a team by connecting with other inventors to develop the idea or invention into a product. Further, the method allows the inventor to send an investment request to the one or more investor present in the online platform. Further, the method allows the inventor to search other inventions or idea through a search box provided by the online platform. Further, the method allows the inventor to invest in on or more inventions of interest.

Now referring to FIG. 2, there is shown a flow chart of a method for investing in an invention of interest through the online platform. The method allows an investor to start a registration process by accessing the online platform via a computing device through wired or wireless communication at step 6. Further, the registration process includes a step of creating User ID and password of the investor. Further, the method allows the investor to send personal information to the online platform through the computing device via the internet, for completing the registration process. Further, the personal information of the student/inventor includes a first name, last name, professional information, and the like. Thereafter, the investor is adapted to create a market place bank account through the online platform by sending an account opening request to the online platform at step 7. After creating an account, the method allows the investor to invest in one or more desired invention at step 8.

In one embodiment of the present invention, the investor is adapted to search a desired invention through a search box provided by the online platform via the computing device. The online platform is adapted to display various filters to assist investors in searching and deciding on which invention or idea they would like to invest. Further, the filters include an invention budget, the development status of the invention, market value of the invention, funds associated with the invention, numbers of investors linked to the invention, inventor ranking and the like. Further, the method allows an investor to select one or more invention from a list displayed by the online platform on the investor computing device for investing purposes. Further, the online platform is adapted to facilitate an investment transaction between the investor and the inventor.

In one embodiment of the present invention, the online platform is adapted facilitates investment in an inventor's invention by providing the invention to potential investors at preliminary stages of invention development, allowing investors to fund inventor's activities such as searching, product development, commercialization of product, marketing and patent application drafting and filing. Investors may continue to invest after patent application drafting.

Further, the online platform includes a virtual asset management module which helps the investors to choose which product they would like to invest, by providing a list of potential inventions based on the investor profile. Further, the virtual asset management module is adapted to allow the investor to manage one or more invention in which the investor had invested his money. Further, the virtual asset management module is adapted track and notify the invention status. Further, the virtual asset management module helps the investor to create an agreement with the inventors to patent, license and manufacture the desired invention.

In one embodiment of the present invention, the online platform is adapted to provide a social network platform which helps the investor to form a venture capital team by communication with other investors.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A method performed by a processor enabled device for developing and commercializing an invention, comprising:
receiving, by a server, at least one invention idea from at least one inventor through an inventor computing device via network communication, wherein said at least one invention idea includes at least one invention parameter and at least one inventor activity;
providing ranking level to said at least one invention idea based on said at least one invention parameter by said server;
storing, by said server, said at least one invention idea with said at least said ranking level in an invention database coupled to said server;
receiving at least one invention search request from at least one investor via an investor computing device by said server via said network communication;
retrieving said at least one invention idea, based on said at least one invention search request based on said at least one invention search request, from said database by said server;
creating a dynamic list of said retrieved invention idea based on said ranking level;
providing said dynamic list to said investor computing device by said server via said network communication; and
allowing said at least one investor to select said at least one invention idea from said list provided by said server to said investor computing device, for investing funds in said at least one invention idea, wherein said investing funds is used in said at least one inventor activity.

2. The method according to claim 1, wherein said inventor computing device, said investor computing device and said server are adapted to send and receive data via network communication.

3. The method according to claim 1, wherein said inventor computing device, said investor computing device and said server is a processor enable device having a memory, a display and communication interface.

4. The method according to claim 1, wherein said at least one invention idea is selected from the group of a text, digital content, program, user interface, coding, website or software program codes, invention description or claim, abstract idea, product model, 3D digital model, image, business idea, image, information of any idea and combination thereof.

5. The method according to claim 1, wherein said at least one invention parameter is selected from the group of an inventor profile, inventor profession, education and skills, technology used in said at least one invention idea, utility, scope of the invention, advantage over prior invention, industrial application, novel aspects, market scope and the combinations thereof.

6. The method according to claim 1, wherein said at least one inventor activity is selected from the group of a patent filing, drafting, product development, commercialization, promotion, branding, advertising, hiring of resources, manufacturing and the combination thereof.

7. The method according to claim 1, wherein said database is stored in a memory unit of said server via network communication.

8. The method according to claim 1, wherein said database remotely connected to said server via network communication.

9. The method according to claim 1, wherein said network communication is selected from the group of a wired communication, wireless communication and combination thereof.

10. The method according to claim 1, wherein said invention search request is selected from the group of text, number, alphanumeric, symbol, image and the combination thereof provided by said at least one investor via an investor computing device.

11. The method according to claim 1, wherein said invention search request is executed by selecting at least one filter provided by said server to said investor computing device.

12. The method according to claim 11, wherein said least one filter is selected from the group of a technology domain, inventor name, title, date, industrial application, utility and the combination thereof.

13. The method according to claim 1, wherein said investing funds in said at least one invention idea comprises:
creating a predefined contract between said at least one inventor and said at least one investor, wherein said predefined contract, if accepted between said at least one inventor and said at least one investor;
establishing a fund transaction link between said at least one inventor computing device and said at least one investor computing device via a payment gateway provided by said server via network communication;
receiving funds from said at least one investor according to said predefined contract;
transmitting said received funds to said at least one inventor account; and
sending a transaction completion notification to said at least one inventor computing device and said at least one investor computing device.

14. The method according to claim 13, wherein said predefined contract is selected from the group of a joint development agreements, licensing and cross-licensing agreements, and assignments of patent rights, copyright, profit sharing, revenue sharing, general contracts, contract services and the combination thereof.

15. The method according to claim 1, further comprises applying a standardized set of agreements prior to disclosure of said invention idea between said at least one investor and said at least one inventor.

16. The method according to claim 1, further comprises allowing said at least one inventor to access at least one invention developing interface provided by said server, for developing a 3D prototype model based on said at least one invention idea.

17. The method according to claim 1, wherein at least one invention developer interface is a 3D geometric software for developing a 3D and 2D prototype product model.
